(19) United States
(12) Patent Application Publication
(10) Pub. No.: US 2013/0036236 A1
(43) Pub. Date: Feb. 7, 2013

(54) METHOD AND SYSTEM FOR CREATING PEER-TO-PEER GEOGRAPHICAL ROUTING AND MULTI-ATTRIBUTE SIMILARITY ROUTING

(71) Applicants: Ramses Morales, Rochester, NY (US); Yu-An Sun, Webster, NY (US)

(72) Inventors: Ramses Morales, Rochester, NY (US); Yu-An Sun, Webster, NY (US)

(73) Assignee: Xerox Corporation, Norwalk, CT (US)

(21) Appl. No.: 13/195,358

(22) Filed: Aug. 1, 2011

(51) Int. Cl. G06F 15/173

(52) U.S. Cl. 709/238

(57) ABSTRACT

A system and method for creating a peer-to-peer geographical routing overlay network and a multi-attribute similarity routing overlay network. The geographical overlay network can be generated utilizing a geographical routing protocol to organize connections between one or more distributed micro-markets depending on a geographical location of each market and to detect a geographically close neighbor in a decentralized manner. The multi-attribute similarity overlay network can be computed by applying a filtering function based on a multi-attribute routing protocol defined over at least one attribute in order to enable decentralized clustering of the distributed micro-markets. The multi-attribute similarity protocol can be combined with the geographic overlay protocol to route messages to a target set of similarity-based attributes and a target geographic location thereby dynamically evolve a structure of distributed micro-markets over time and optimize a market interaction in the overlay network.

### TECHNICAL FIELD

Embodiments are generally related to distributed micro-markets. Embodiments are also related to self-organizing overlay networks. Embodiments are additionally related to the creation of a peer-to-peer geographical routing and multi-attribute similarity routing.

### BACKGROUND OF THE INVENTION

Micro-markets are distributed host systems that operate as isolated sites within a network environment (e.g., the Internet). Such micro-market sites can be employed for designing, creating, and manufacturing products, marketing strategies, and/or advertising campaigns with respect to a specific segment of a user's access to a micro-market system. Data such as, for example, job-positing data (e.g., a customer request for proposal (RFP) and/or a bid with respect to a particular marketing site) can be only viewed by a particular user (e.g., a RFP creator and a bidder) who has access or belongs to that particular marketing site. Users belonging to other marketing sites, however, are unable to access and view the data (e.g., job positing data) of that particular marketing site.

A self-organizing overlay network can be created with respect to the micro-markets for communicating and exchanging data (e.g., job-positing data) between users of different sites in the network. Such self-organizing overlay networks typically enable users of the multiple micro-markets to learn about, for example, relevant job-postings created in other market environments. An overlay network also provides an opportunity for users to interact across the network and increase the revenue of both the users and marketers in the network.

Prior art self-organizing overlay networks do not directly address the features herein to allow interaction between previously isolated micro-markets. Such prior art overlay networks are not designed to allow micro-markets to effectively share data (e.g., job-posting data) with respect to a broad array of evolving customer needs. In order to effectively compute and share data within the network environment, micro-markets will require additional infrastructure. Furthermore, markets in the overlay network may misbehave by adding undesired job-postings in order to “spam” a competitor market, or may decide not to follow the protocol in other “selfish” ways.

Based on forgoing, it is believed that a need exists for an improved system and method for creating a peer-to-peer geographical routing and a multi-attribute similarity routing in order to effectively exchange data between evolving distributed micro-markets. A need also exists for an improved method for routing messages to a target set of similarity-based attributes and a target geographic location, as described in greater detail herein.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved networked micro-market system and method.

It is another aspect of the disclosed embodiments to provide for an improved system and method for creating a peer-to-peer geographical routing overlay network.

It is further aspect of the disclosed embodiments to provide for an improved system and method for creating a multi-attribute similarity routing overlay network.

It is yet another aspect of the disclosed embodiments to provide for an improved method for routing messages to a target set of similarity-based attributes and a target geographic location in order to effectively exchange data between evolving distributed micro-markets.

The aforementioned aspects and other objectives and advantages can now be achieved as described herein. A system and method for creating a peer-to-peer geographical routing overlay network and a multi-attribute similarity routing overlay network is disclosed herein. The geographical overlay network can be generated utilizing a geographical routing protocol to organize connections between one or more distributed micro-markets depending on a geographical location of each market and to detect a geographically close neighbor in a decentralized manner. The multi-attribute similarity overlay network can be computed by applying a filtering function (e.g., Bloom filter) based on a multi-attribute routing protocol defined over or based on one or more attributes, such as, for example, a skill set (e.g., a job-posting skill set and/or a bidder skill set) in order to enable decentralized clustering of similar markets. The multi-attribute similarity protocol can be combined with the geographic overlay protocol to route messages to a target set of similarity-based attributes and a target geographic location thereby dynamically evolve a structure of distributed micro-markets over time and optimize a market interaction in the overlay network.

The geographic overlay network group together nodes that are geographically close utilizing a low-overhead protocol, and simultaneously permit each node to learn regarding a small number of nodes that are geographically close. Each node has a geographic location attribute that includes a latitude and longitude of the node and/or x and y co-ordinate in a two-dimensional plane. The message geographic location can be assumed to be set at creation time and may not be equal to the geographic location of any node in the overlay. A distance function can be computed in order to determine the distance between two nodes and/or a node and a message. If the geographic location is represented with actual latitude and longitude degree, then Harversine formula can be applied to determine the distance function. If the geographic location is represented with x and y coordinates in the plane then the Euclidean distance between two points can be utilized to determine the distance function.

A message tagged with the geographical location can be routed, in such a way that the message can arrive to the market that is geographically closest to the geographical location of the message. At each hop, the geographic location of the message can be compared to the geographic location of the node the message is currently in and the geographic location of the neighbors of that node. The comparison can be done utilizing the distance function. If the current node is the closest node to the message then the routing can be stopped. If instead one of the neighbors of the node is closer to the message then the message can be forwarded to that node.

The nodes can periodically gossip the location to all the close neighbors along with a maximum and minimum distance to neighbors from a close neighbor list. The receiving node may determine if the node can be a better neighbor for an originating node by utilizing the location and maximum and minimum values. The receiving node can add the originating node to its close neighbor list potentially dropping another node from the list. The not-close list can be periodically updated by initiating a random walk utilizing one node from the list. The random walk can be performed by a message that contains the location of the originator and the distance to the furthest node in the close neighbor list. At each hop, the message can be forwarded to a random neighbor, chosen from among the neighbors that are at a further distance than the one contained in the message.

The similarity-based overlay network also maintains a number of neighbor lists, one for each market attribute that needs to be utilized to cluster similar markets together. If a particular market desires to transmit message to another market similar to itself with regards to an attribute, then the market can consult the attributes neighbor list, maintained by the similarity overlay. The single attribute routing of any message can always take one hop, unless there are no markets similar to the market on the desired attribute. The geographic based overlay can be combined with the similarity overlay to permit the market to transmit the message to any other market that is both similar to the originating market and close to a desired location. Such an approach can provide a flexible platform to effectively exchange data while-ensuring scalability and fault tolerance with respect to the micro-markets.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a system that includes an overlay network management module, an operating system, a user interface, and a micro-market software application in accordance with the disclosed embodiments;

FIG. 2 illustrates a graphical representation of a networked micro-market system being a member of a similarity-based overlay network, in accordance with the disclosed embodiments;

FIG. 3 illustrates a block diagram of a networked micro-market system, in accordance with the disclosed embodiments; and

FIG. 4 illustrates a high level flow chart of operations illustrating logical operational steps of a method for creating and combining a peer-to-peer geographical routing overlay network and a multi-attribute similarity routing overlay network, in accordance with the disclosed embodiments.

### DETAILED DESCRIPTION

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, the present invention can be embodied as a method, data processing system, or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, etc.

Computer program code for carrying out operations of the present invention may be written in an object oriented programming language (e.g., Java, C++, etc.) The computer program code, however, for carrying out operations of the present invention may also be written in conventional procedural programming languages, such as the “C” programming language or in a visually oriented programming environment, such as, for example, VisualBasic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiFi, Wimax, 802.xx, and cellular network or the connection may be made to an external computer via most third party supported networks (for example, through the Internet using an Internet Service Provider).

The invention is described in part below with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

Although not required, the disclosed embodiments will be described in the general context of computer-executable instructions, such as program modules, being executed by a single computer. In most instances, a “module” constitutes a software application. Generally, program modules include, but are not limited to routines, subroutines, software applications, programs, objects, components, data structures, etc., that perform particular tasks or implement particular abstract data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

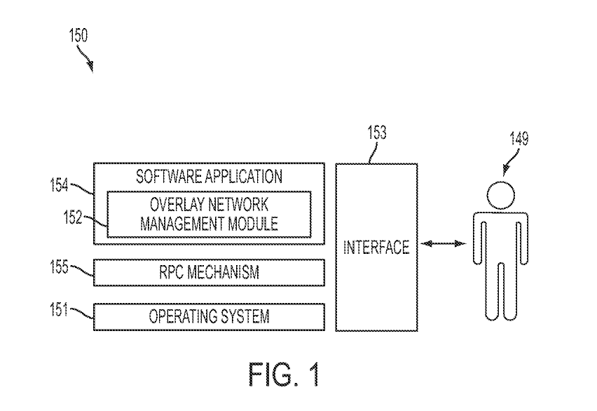

Referring now to FIG. 1, a system 150 is illustrated, which includes an overlay network management module 152, an operating system 151, a micro-market software application 154 and a user interface 153 with respect to a user 149, in accordance with the disclosed embodiments. Note that the micro-market software application 154 can be stored in a memory of, for example a data-processing apparatus (not shown in FIG. 1). System 150 thus includes a kernel or operating system 151 and a shell or interface 153 and one or more application programs, such as the micro-market software application 154.

In general, the operating system 151 can be composed of programs (e.g., modules) and data that run on computers or other data-processing devices or systems, and which manages the computer hardware and provides common services for efficient execution of various application software, such as, for example, the micro-market software application 154 and/or the overlay network management module 152. For hardware functions such as input and output and memory allocation, the operating system 151 can function as an intermediary between application programs and the computer hardware, although in most embodiments, the application code is usually executed directly by the hardware, but will frequently call the operating system 151 or be interrupted by it.

Note that the overlay network management module 152 is not required to be directly on top of the same operating system 151 as the micro-market software application 153. That is, the overlay network management module 152 can reside in a different host and can communicate utilizing an RPC (Remote Procedure Call) mechanism 155. It is important, however, that such components are located generally within the same LAN (Local Area network). Note that the RPC mechanism 155 implements a Remote Procedure Call, which is an inter-process communication that allows a computer program to cause a subroutine or procedure to execute in another address space (commonly on another computer on a shared network) without the programmer explicitly coding the details for this remote interaction. That is, the programmer writes essentially the same code whether the subroutine is local to the executing program, or remote. When the software in question uses object-oriented principles, for example, RPC may be referred to as remote invocation or a remote method invocation.

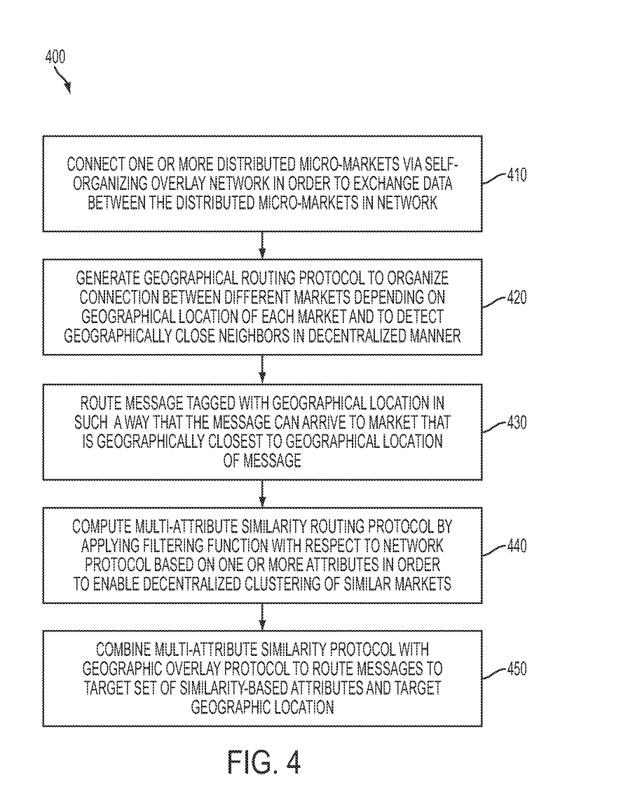

The interface 153, which is preferably a GUI (Graphical User Interface), can serve to display results, whereupon a user may supply additional inputs or terminate a particular session. The micro-market software application 154 is generally associated with the overlay network management module 152 for creating a peer-to-peer geographical routing and multi-attribute similarity routing in order to efficiently exchange data between users of different micro-markets. The overlay network management module 152 can include instructions, such as those of method 400 discussed herein with respect to FIG. 4.

FIG. 1 is thus intended as an example, and not as an architectural limitation of the disclosed embodiments. Such embodiments, however, are not limited to any particular application or any particular computing or data-processing environment. Instead, those skilled in the art will appreciate that the disclosed system and method may be advantageously applied to a variety of system and application software. Moreover, the present invention may be embodied on a variety of different computing platforms, including Macintosh, UNIX, LINUX, and the like.

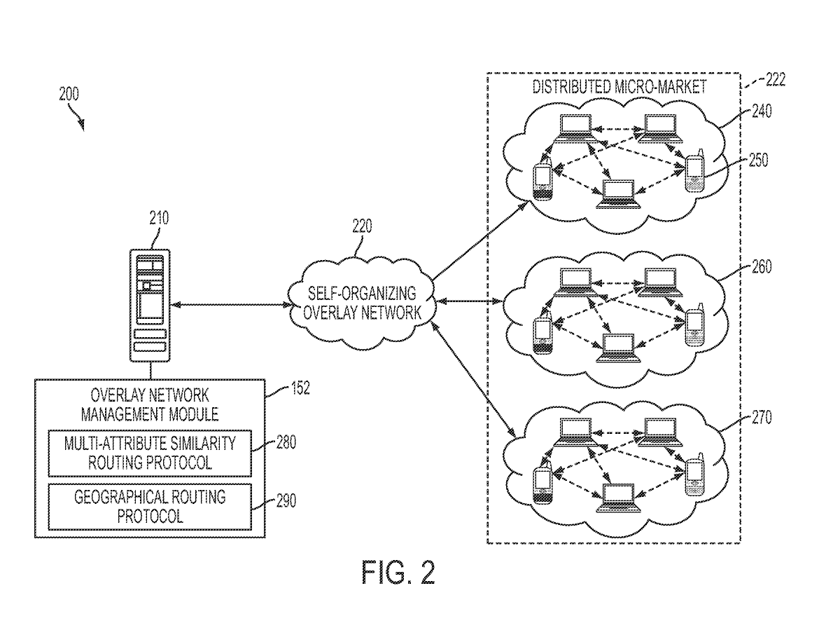

FIG. 2 illustrates a graphical representation of a networked micro-market system 200 being a member of a self-organizing overlay network 220, in accordance with the disclosed embodiments. Note that in FIGS. 1-4 identical parts or elements are generally indicated by identical reference numerals. The networked micro-market system 200 generally includes one or more distributed micro-markets 240, wherein each of the market(s) 240 includes a management server 210 configured with the overlay network management module 152. The management server 210 can communicate with the self-organizing overlay network 220, which in turn can communicate with other distributed markets indicated in FIG. 2 by block 222. Note that block 222 indicates that the self-organizing overlay network 220 is built from distributed markets that participate in the disclosed protocol. The distributed micro-market(s) can be connected via the self-organizing overlay network 220, which is a form of a peer-to-peer (P2P) connection technology in order to exchange data (e.g., job-posting data) between the distributed micro-markets 240 in the network 220.

The self-organizing overlay network 220 can be configured as a powerful abstraction that creates a virtual network of connected devices layered on an existing underlying network in order to provide new network functionality. Such overlay networks 220 may be employed to construct content services networks in a wide range of networking applications. The overlay network 220 also ensures trust, integrity and security of the data transmitted between the nodes. Note that the nodes in the overlay network 220 can be, for example, a single micro-market.

The management server 210 along with the overlay network management module 152 effectively manages and ensures the communication between the distributed micro-markets 240, thus building the overlay network 220. The overlay network management module 152 can also be configured to advertise customer data with respect to relevant micro-markets 240 in order to avoid selfish and rational behaviors between the markets 240. The distributed micro-markets 240 can be operatively connected via the self-organizing overlay network 220 (e.g., a form of a peer-to-peer network) in order to exchange data between the distributed micro-markets 240 in the network 220. The overlay network management module 152 further includes a multi-attribute routing protocol 280 and a geographical routing protocol 290 in order to route messages to a target set of similarity-based attributes and a target geographic location. The self-organizing overlay network 220 effectively ensures scalability and fault tolerance with respect to the users of the micro-markets 240. The overlay network 220 is designed in a completely distributed and decentralized manner in order to provide a flexible platform to effectively exchange the customer data with respect to a broad array of evolving market characteristics.

The networked micro-market system 200 is the Internet with the self-organizing overlay network 220 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, networked micro-market system 200 also may be implemented as a number of different types of networks, such as for example, an intranet, a local area network (LAN), or a wide area network (WAN). Note that the configuration depicted in FIG. 2 is intended as an example, and is not an architectural limitation with respect to different embodiments of the present invention.

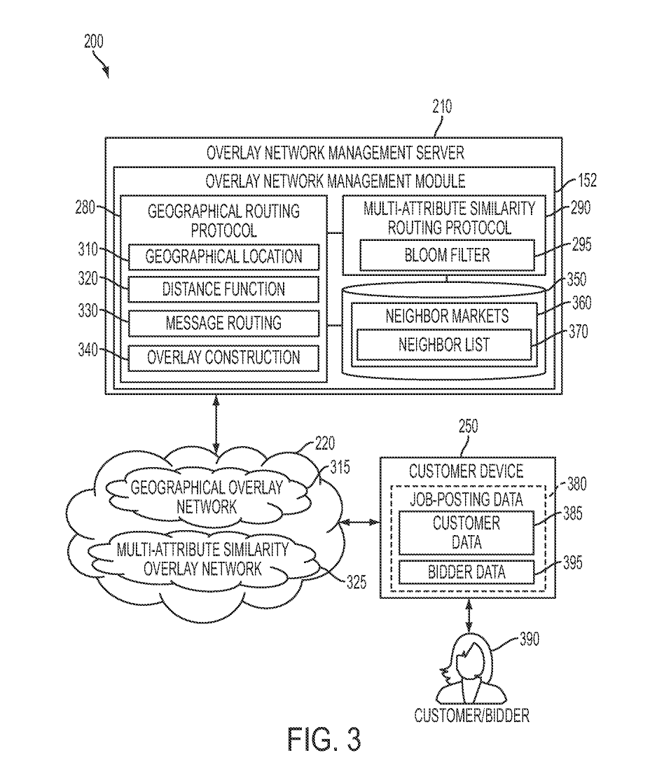

FIG. 3 illustrates a block diagram of a networked micro-market system 300, in accordance with the disclosed embodiments. In general, the networked micro-market system 300 includes server 210, which can function as a micro-market and overlay network management server. Note that the server 210 shown in FIG. 3 is analogous to the management server 210 depicted in FIG. 2, although it can be appreciated that such servers may vary from one another, depending upon design considerations.

The self-organizing overlay network 220 can be configured to include a geographic overlay network 315 and a multi-attribute overlay network 325. The overlay network management module 152 is associated with the network management sever 210 and generally includes the multi-attribute routing protocol 280 and the geographical routing protocol 290. The overlay network management module 152 can also include a database 360, which includes data indicative of neighbor markets 360. As indicated in FIG. 3, a customer device 250 can communicate with the server 210. The customer device 250 of the micro-market(s) 240 can provide, for example, remote data 380, which can include, for example, customer RFP (Request For Proposal) data 385 and/or bidder data 395, in order to communicate the data 380 between user(s) 390 within the network 220. The user 390 with respect to the customer device 250 can be, for example, a customer and/or a bidder of the micro-market 240. Note that the customer device 250 can be, for example, a computing device such a wireless PDA (Personal Digital Assistant), Smartphone, personal computer, laptop computer, or other types of computing devices such as a computer server, and so forth.

The geographic overlay network 315 organizes connections between the markets 240 depending on a geographical location 310 of each market in order to determine geographically close neighbors in the decentralized manner. The geographic routing protocol 290 routes a message tagged with the geographical location 310, in such a way that the message can arrive to the market that is geographically closest to the geographical location 310 of the message. The geographic routing protocol 290 is a peer-to-peer system created in a self-organizing way by participating nodes (or peers) utilizing their geographic location 310 as main organizing metric. The geographic routing protocol 290 group together nodes that are geographically close utilizing a low-overhead protocol, and simultaneously permit each node to learn regarding a small number of nodes that are geographically close.

For example, consider the overlay network 315 is built from a set of N nodes, and each node includes a geographic location attribute that includes a latitude and longitude of the node and/or x and y co-ordinate in a two-dimensional plane. The attributes can be assigned based on the application. A particular instance can utilize the actual geographical location of the physical host (or data-center) that can be represented via the overlay node. Another instance can utilize the logical location of the node. For example, a technical start up in Boston with servers hosted in New York, can choose to utilize the actual place of business operation (Boston) as the geographic location. The message geographic location can be assumed to be set at creation time and not necessarily correlated with the node where the message originated. The message geographic location may not be equal to the geographic location of any node in the overlay network 315. Note that as utilized herein the term “node” can refer to a market.

The geographic routing protocol 290 further computes a distance function 320 in order to determine the distance between two nodes or a node and a message. If the geographic location 310 is represented with actual latitude and longitude degree, then Harversine formula can be applied to determine the distance between the nodes or a node and a message. The Harversine formula is an equation, giving great-circle distances between two points on a sphere from their longitudes and latitudes. If the geographic location 310 is represented with x and y coordinates in the plane then the Euclidean distance between two points can be utilized to determine the distance. In mathematics, the Euclidean distance or Euclidean metric is the “ordinary” distance between two points measured with a ruler, and is given by the Pythagorean formula. By using this formula as distance, Euclidean space (or even any inner product space) becomes a metric space.

A message routing 330 can be performed in a greedy fashion. The entries in the neighbor list 370 can represent edges in the overlay network 220. The neighbor list 370 can include a subset of nodes that are not close enough to be in the first list. The geographic routing protocol 290 further compares the geographic location of the message at each hop to the geographic location of the node the message is currently in and the geographic location of the neighbors of that node in order to route message 330. The comparison can be done utilizing the distance function 320. If the current node is the closest node to the message then the routing stop. If instead one of the neighbors of the node is closer to the message then the message can be forwarded to that node.

A geographic overlay construction 340 can be performed to route messages tagged with a geographical location, in such a way that the message can arrive to the market that is geographically closest to the geographical location of the message. For example, when a new node i joins, it can contact a node j already present in the overlay. The node j can then route the message utilizing node i's geographic location as the message's geographic location. The node j′ where the message stops can transmit both its neighbor lists to the node i, and i can utilize those lists to initially populate its own lists. Finally, node i will contact all its new neighbors in order to learn of node i's presence, which can potentially lead them to update their lists.

The nodes can periodically gossip the location to all their close neighbors along with a maximum and minimum distance to the neighbors from a close neighbor list in order to maintain the close neighbor list. When a node j receives such a message it can choose to forward the message or drop the message. If node j possesses a neighbor that falls between the maximum and minimum values of the message, node j forwards the gossip to that neighbor. If node j has no such neighbor, then the message is not forwarded. The receiving node may determine if it can be a better neighbor for an originating node by utilizing the location and maximum and minimum values. The receiving node can add the originating node to its close neighbor list potentially dropping another node from the list.

The not-close list can be periodically updated by initiating a random walk utilizing one node from the list. The random walk can be performed by a message that contains the location of the originator and the distance to the furthest node in the close neighbor list. At each hop, the message can be forwarded to a random neighbor, chosen from among these neighbors that are at a further distance than the one contained in the message. The message stops after c=log (N) steps, where c is a system-wide integer constant. The node where the message stops can contact the originator, and the originator may include that receiver in the not-close list, potentially dropping a random neighbor from that list if the list is full.

The multi-attribute similarity routing protocol 290 can be computed by applying a filtering function 295 (e.g., Bloom filter) with respect to a network protocol that is defined over or based on one or more attributes, such as, for example, a skill set in order to enable decentralized clustering of similar markets. Note that the bloom filter 320 is a data structure that allows for memory efficient and computationally fast set membership-tests. The multi-attribute similarity routing protocol 290 can be computed by correlating, for example, the attributes (e.g., skill sets) of the data 380 (e.g., job-posting data) with respect to the micro-markets 240 in the network 220. Note that the skill set disclosed herein can be such as, for example, a job-posting skill set and/or a bidder skill set. The market similarity function 325 can be also computed based on a market characteristic such as, payments and market age characteristics.

The similarity-based overlay network 325 also maintains a number of neighbor lists 370, one for each market attribute that needs to be utilized to cluster similar markets together. If a particular market node i need to transmit a message to another market similar to itself with regards to attributes A, then node i can consult A-neighbor list, maintained via the similarity-based overlay 325. In other words, single attribute routing of any message always take one hop, unless there are no markets similar to node i on the desired attribute. To route message to a market that can be similar in more than one attribute, the following can be performed. First, node (alt. market) i can compute the interaction among the desired attribute-neighbor-list's (e.g., if attribute A and C are desired then the interaction between A-neighbor-list and C-neighbor-list can be computed). If the intersection is non-empty, the message can be directly transmitted to any of those neighbors. If the intersection is empty, then node i can transmit a compute-intersection message to its neighbor in the pertinent neighbor list (e.g., A-neighbor-list and C-neighbor-list).

The nodes receiving the message can then try to determine an intersection in their respective neighbor list for the desired attributes (e.g., node j will try to determine and intersection between its A-neighbor-list and C-neighbor-list). Any node with a resulting non-empty set, will return set to node i, and i can then verify that markets included in the set are similar to node i on the desired attributes (e.g., node i will apply the similarity function for attribute A and C on each member of the returning sets), if there are any nodes that are similar, then node i can directly transmit the desired message to any of those nodes. Such an approach works because if market node i similar to market node j on attribute A, and market node j is similar to market node j′ on attribute A, then there is a better chance that node i and j′ are also similar on attribute A.

The multi-attribute similarity overlay network 325 can be combined with the geographic overlay network 315 to route messages to a target set of similarity-based attributes and a target geographic location. The geographic based overlay network 315 can be combined with the similarity overlay network 325 to permit the market transmit the message to any other market that is both similar to the originating market and close to a desired location. First, the message from market node i can be routed geographically. Thereafter, a modification can be made to the geographic routing protocol 280, once the message stops at the market node j that is closest to the message's geographic location, the message can be replicated to k (this is a system-wide parameter) neighbors of node j that are closest according to the geographic overlay. Finally, once the replicated message arrives, each receiving market can identify itself to node i, thus letting i verify if those markets that are geographically close to the message's geographic location are similar to node i on the desired attributes. Such an approach can provide a flexible platform to effectively exchange data while-ensuring scalability and fault tolerance with respect to the micro-markets.

FIG. 4 illustrates a high level flow chart of operations illustrating logical operational steps of a method 400 for creating and combining the peer-to-peer geographical routing overlay network 315 and the multi-attribute similarity routing overlay network 325, in accordance with the disclosed embodiments. Note that the method 400 can be implemented in the context of a computer-usable medium that contains a program product, including, for example, a module or group of modules. One or more distributed micro-markets can be operatively connected via the overlay networks 315 and 325 (e.g., a form of a peer-to-peer network) in order to exchange data between the distributed micro-markets 240 in the network, as indicated at block 410. Thereafter, as illustrated at block 420, the geographical routing protocol 290 can be generated to organize connections between different markets 240 depending on the geographical location 310 of each market and to detect geographically close neighbors in a decentralized manner.

Next, a message tagged with the geographical location 310 can be routed, in such a way that the message can arrive to the market that is geographically closest to the geographical location of the message, as depicted at block 430. The multi-attribute similarity routing protocol 290 can be computed by applying a filtering function (e.g., Bloom filter) with respect to a network protocol that is defined over or based on one or more attributes in order to enable decentralized clustering of similar markets, as shown at block 440. The multi-attribute similarity protocol 290 can be combined with the geographic overlay protocol 280 to route messages to a target set of similarity-based attributes and a target geographic location, as indicated at block 450.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method, comprising:
generating a geographical overlay network utilizing a geographical routing protocol to organize connections between a plurality of distributed micro-markets depending on a geographical location of each market and to detect a geographically close neighbor in a decentralized manner;
computing a multi-attribute similarity overlay network with respect to said plurality of distributed micro-markets by applying a filtering function based on a multi-attribute routing protocol defined over at least one attribute in order to enable decentralized clustering of said plurality of distributed micro-markets; and
combining said multi-attribute similarity protocol with said geographic overlay protocol to route a message to a target set of similarity-based attributes and a target geographic location thereby dynamically evolve a structure of said plurality of distributed micro-markets over time and optimize a market interaction in said overlay network.

2. The method of claim 1 wherein generating said geographical overlay network further comprises:
grouping a plurality of nodes that are geographically close utilizing a low-overhead protocol and simultaneously permitting each node to learn regarding a small number of nodes that are geographically close.

3. The method of claim 1 wherein said node possess at least one geographic location attribute and said message geographic location is set at creation time.

4. The method of claim 1 wherein said at least one geographic location attribute includes at least on of the following types of attributes:
a latitude and longitude of said node; and
x and y co-ordinate in a two-dimensional plane.

5. The method of claim 1 wherein generating said geographical overlay network further comprises:
computing a distance function in order to determine distance between at least two nodes and/or a node and a message;
routing said message tagged with said geographical location in such a way that said message can arrive to said market that is geographically close to said geographical location of said message; and
comparing said geographic location of said message to said geographic location of said node associated with said message and said geographic location of a neighbor of said node at each hop utilizing said distance function.

6. The method of claim 5 further comprising applying Harversine formula to determine said distance function if said geographic location is represented with said latitude and longitude attribute.

7. The method of claim 5 further comprising determining said distance function utilizing Euclidean distance between two points if said geographic location is represented with x and y coordinates in said plane.

8. The method of claim 1 further comprising stopping routing of said message if a current node is a closest node to said message and forwarding said message to said node if a neighbor of said node is close to said message.

9. The method of claim 1 wherein generating said geographical overlay network further comprises:
periodically gossiping said node location with respect to a plurality of close neighbors in association with a maximum and minimum distance from a close neighbor list wherein said receiving node determine if said node is a better neighbor for an originating node utilizing said node location and said maximum and minimum distance;
adding said originating node to said close neighbor list by said receiving node and potentially dropping another node from said list; and
periodically updating a not-close list by initiating a random walk utilizing at least one node from said list.

10. The method of claim 9 further comprising:
performing said random walk by said message that includes location of said originator node and distance to a furthest node in said close neighbor list; and
forwarding said message at each hop to a random neighbor chosen from among said plurality of neighbors that are at a further distance than the one contained in said message.

11. The method of claim 1 wherein generating said multi-attribute similarity overlay network further comprises:
maintaining said plurality of neighbor lists one for each market attribute in order to cluster similar market together; and
consulting an attribute neighbor list maintained by said similarity overlay network by said market if said market desires to transmit message to another market similar to itself with regards to an attribute.

12. The method of claim 1 further comprising combining said geographic overlay network with said similarity overlay network to permit said market transmit said message to any other market that is both similar to an originating market and close to a desired location.

13. The method of claim 1 wherein said filtering function comprises a Bloom filter.

14. The method of claim 1 further comprising connecting said plurality of distributed micro-markets is a peer-to-peer connection computing arrangement.

15. A system, comprising:
a processor;
a data bus coupled to said processor; and
a computer-usable medium embodying computer code, said computer-usable medium being coupled to said data bus, said computer program code comprising instructions executable by said processor and configured for:
generating a geographical overlay network utilizing a geographical routing protocol to organize connections between a plurality of distributed micro-markets depending on a geographical location of each market and to detect a geographically close neighbor in a decentralized manner;
computing a multi-attribute similarity overlay network with respect to said plurality of distributed micro-markets by applying a filtering function based on a multi-attribute routing protocol defined over at least one attribute in order to enable decentralized clustering of said plurality of distributed micro-markets; and
combining said multi-attribute similarity protocol with said geographic overlay protocol to route a message to a target set of similarity-based attributes and a target geographic location thereby dynamically evolve a structure of said plurality of distributed micro-markets over time and optimize a market interaction in said overlay network.

16. The system of claim 15 wherein said instructions are further configured for grouping a plurality of nodes that are geographically close utilizing a low-overhead protocol and simultaneously permitting each node to learn regarding a small number of nodes that are geographically close.

17. The system of claim 15 wherein said node possess at least one geographic location attribute and said message geographic location is set at creation time.

18. The system of claim 15 wherein said at least one geographic location attribute includes at least on of the following types of attributes:
a latitude and longitude of said node; and
x and y co-ordinate in a two-dimensional plane.

19. The system of claim 15 wherein said instructions are further configured for:
computing a distance function in order to determine distance between at least two nodes and/or a node and a message;
routing said message tagged with said geographical location in such a way that said message can arrive to said market that is geographically close to said geographical location of said message; and
comparing said geographic location of said message to said geographic location of said node associated with said message and said geographic location of a neighbor of said node at each hop utilizing said distance function.

20. A processor-readable medium storing code representing instructions to cause a processor to perform a process, said code comprising code to:
generate a geographical overlay network utilizing a geographical routing protocol to organize connections between a plurality of distributed micro-markets depending on a geographical location of each market and to detect a geographically close neighbor in a decentralized manner;
compute a multi-attribute similarity overlay network with respect to said plurality of distributed micro-markets by applying a filtering function based on a multi-attribute routing protocol defined over at least one attribute in order to enable decentralized clustering of said plurality of distributed micro-markets; and
combine said multi-attribute similarity protocol with said geographic overlay protocol to route a message to a target set of similarity-based attributes and a target geographic location thereby dynamically evolve a structure of said plurality of distributed micro-markets over time and optimize a market interaction in said overlay network.
